(19) United States
(12) Patent Application Publication
(10) Pub. No.: US 2008/0138247 A1
(43) Pub. Date: Jun. 12, 2008

(54) Liquid Detection and Confidence Determination

(75) Inventors: Mats Inganas, Uppsala (SE); Tobias Soderman, Balinge (SE); Erik Hogstrand, Uppsala (SE)

Correspondence Address: FULBRIGHT & JAWORSKI L.L.P, 2200 ROSS AVENUE, SUITE 2800, DALLAS, TX, 75201-2784, US

(73) Assignee: GYROS Patent AB, Uppsala (SE)

(21) Appl. No.: 11/719,078

(22) PCT Filed: Nov. 10, 2005
(86) PCT No.: PCT/SE05/01691

§ 371 Date: Oct. 8, 2007

Related U.S. Application Data
(60) Provisional application No. 60/626,477, filed on Nov. 10, 2004.

(30) Foreign Application Priority Data
Nov. 10, 2004 (SE) 0402731-4

(51) Int. Cl. G01J 3/00; B01J 19/00; G01N 35/00

(52) U.S. Cl. 422/82.05; 422/68.1; 73/1.02

(57) ABSTRACT

A method and a system for grading the confidence of a result of an experiment that comprises one or more biological and/or chemical reactions and is carried out in a microchannel structure (110a) of a microfluidic device, said confidence determination comprises the steps of: i) detecting within each of at least one liquid detector segment of said microchannel structure (110a) the presence or absence of liquid and/or gas during a period of time for which it is known if liquid and/or gas shall be present and/or absent in the segment, and ii) assigning a lowered confidence to said result if the presence and/or absence of liquid and/or gas found in step (i) is deviating from what it shall be.

### TECHNICAL FIELD

The present invention relates to a process in a microfluidic system.

More specifically, the present invention relates to a method for quality assessment of the performance of an experiment that is carried out within a microchannel structure of a microfluidic device. The present invention also relates to a method for confidence determination, a method for liquid detection in a microchannel structure of a microfluidic system and a computer program product and a computer program on a computer usable medium.

### BACKGROUND OF THE INVENTION

The term “microfluidic” refers to a system or device having one or a network of chambers and/or channels, which have micro scale dimensions, e.g., having at least one cross sectional dimension in the range from about 0.1 μm to about 1 μm such as to about 500 μm (depth and/or width). The term also refers to the fact that liquid volumes (aliquots) in the μl-range are transported within the network. The μl-range includes the nl-range as well as the picolitre range. At least one of the aliquots contains at least one reactant, e.g. selected amongst analytes and/or reagents. See further below.

Microfluidic substrates and/or devices are often fabricated using photolithography, wet chemical etching, injection-molding, embossing, and other techniques similar to those employed in the semiconductor industry. The resulting devices can be used to perform a variety of sophisticated chemical and biological experiments including assays for the characterization of various analytes in a sample, separation experiments such as purification experiments, and experiments for the synthesis of organic and/or inorganic compounds such as bio-organic compounds.

Microfluidic analytical systems have a number of advantages over conventional chemical or physical laboratory techniques. For example, microfluidic systems are particularly well adapted for analyzing small sample sizes, typically making use of samples on the order of nanoliters and even picoliters. The microfluidic devices may be produced at relatively low cost, and the channels can be arranged to perform numerous analytical operations, including mixing, dispensing, valving, reactions, detections, electrophoresis, and the like on the same microfluidic device. The analytical capabilities of microfluidic systems and devices are generally enhanced by increasing the number and complexity of network channels, reaction chambers, and the like.

Substantial advances have recently been made in the general areas of flow control and physical interactions between the samples and the supporting analytical structures.

Flow control management may make use of a variety of mechanisms, including the patterned application of voltage, current, or electrical power to the substrate (for example, to induce and/or control electrokinetic flow or electrophoretic separations). Alternatively, fluid flows may be induced mechanically through the application of differential pressure, acoustic energy, or the like. Selective heating, cooling, exposure to light or other kinds of irradiation, or other inputs may be provided at selected locations distributed about the substrate to promote the desired chemical and/or biological interactions. Similarly, measurements of light or other emissions, electrical/electrochemical signals, and pH may be taken from the microfluidic device, e.g. to provide analytical results. As work has progressed in each of these areas, the channel size has gradually decreased while the channel network has increased in complexity, significantly enhancing the overall capabilities of microfluidic systems.

The microfluidics technologies/devices are capable of controlling and transferring tiny quantities of liquids to allow chemical and biological assays and processes to be integrated and accomplished on a small scale. Microfluidics is the miniaturization of chemical and/or biological separation, synthesis and assay techniques to such a degree that multiple “experiments” can be accomplished on a “chip” small enough to fit in the palm of your hand. Tiny quantities of solvent, sample, and reagents are steered through narrow channels on the chip, where they are mixed and analyzed by such techniques as electrophoresis, fluorescence detection, immunoassay, or indeed almost any classical laboratory method.

Today a number of products varying in many respects are available. Laboratory chips may be made from plastic, glass, quartz or even silicon. The fluid may be driven by centrifugal forces, capillary force, mechanical pressure or vacuum pumps, by inertia force, or by one of several electrical methods; fluid flow can be diverted around the chip by mechanical valves, capillary valves, surface tension, voltage gradients, or even electromagnetic forces.

In the technique of using centrifugal forces to drive the fluid the microfluidic device typically is a disc that can be spun. Such discs are preferably circular and typically of the same physical format as conventional CDs (diameter around 12 cm), or rectangular. Liquid samples that are placed at an inner position relative to a spin axis can be transported to an outer position by centrifugal force created as the disc rotates, circumventing the need to design sophisticated electrokinetic or mechanical pumping structures. By also utilizing capillary force liquid transport simply can take place from an outer position to an inner position.

As will become evident in the forth-coming description the present invention is in particular applicable to (but not limited to) micro-analysis systems that are based on micro-channels formed in a rotatable, usually plastic, disc, often called a “lab on a chip” or CD. Such discs can be used to perform analysis and/or separation involving small quantities of fluids as well as for the synthesis of inorganic and organic compounds. In order to reduce costs it is desirable that the discs should be not restricted to use with just one type of reagent/reactant or fluid but should be able to work with a variety of fluids and reactants.

Furthermore it is often desirable during the preparation of samples that the disc permits the user to dispense predetermined volumes of any desired combination of fluids or samples without modifying the disc. Suitable microanalysis channel structures for fluids provided in a rotatable disc are described e.g. in WO 0146465 (Gyros AB), WO 02074438 (Gyros AB), WO 02075312 (Gyros AB), WO 9721090 (Gamera), WO 9853311 (Gamera), WO 0079285 (Gamera), WO 9828623 (Gamera), U.S. Pat. No. 675,296 (Abaxis), U.S. Pat. No. 5,693,233 (Abaxis) etc. A liquid transfer station has a robot that transfer at least one sample or any other predetermined liquid aliquot at a time from the sample and reagent station to a microfluidic device, for instance in the form of a disc that can be spun. The station has means for transfer of liquid samples, and other liquids, for instance a number of injection needles connected to syringe pumps or a number of solid pins may be used for the transfer of samples. Said needles and pins may be configured in different numbers of rows and columns having different distance between the tips in both directions. See for instance WO 9721090 (Gamera), WO 0119518 (Aclara) and the dispensing system used in Gyrolab Workstation (Gyros AB) (summarized in WO 02075775 (Gyros AB)). Another alternative is the microdispensor described in WO 9701085 and the dispensing systems presented in U.S. Pat. No. 6,338,820 (Alexion), US 200300965402 (Gyros AB) etc.

The microfluidic discs may be designed in different ways and may differ individually due to the manufacturing process and/or use. They may have a home position mark relative to which the position coordinates for any part of the surface of the disc may be given, e.g. important parts of each microchannel structure such as inlet ports for liquids, detection areas, the liquid detection segments discussed below, etc. For circular discs, these coordinates may be the angular position relative to the home position mark and the radial position relative to the circumference or axis of symmetry (spin axis) or relative to any other arbitrary fixed position on the disc. See for instance US 20030054563 (Gyros AB), US 20030094502 (Gyros AB), etc

In the best of worlds analytical processes perform according to how they were designed. Processes may, however, be sensitive to aberrant behavior of the assay that may be caused by variations in sample composition, reagent behavior, wash procedures etc. Knowledge of how aberrant results are generated and their causes may be used to also learn how to identify such errors and create possibilities to approve/disapprove the final result. Thus by evaluating significant characteristics in the data generating process one could tell whether the result appear to have been generated according to standards. Results that appear strange should be flagged for deviating quality.

All analytical procedures are performed with the purpose of generating information that is requested or required for further decisions. In order to be useful, information needs to fulfill certain quality goals. Low quality assays require often several replicates in order to generate useful information and is more costly to run for the customer.

A confidence value typically is a measure of data reliability and an estimation for how close a result is to the expected, perfect result, e.g., an estimation of how close the signal distribution in each detection area is to the expected. A high confidence value for an analytic process indicates high quality and reliable data result. On the contrary, a low confidence value indicates low quality and that the data from a particular process or experiment may not be acceptable depending on one or more disturbances in the process. Methods for allotting confidence values to results that are derived from the distribution of the measured signal in the detection areas of microchannel structures of a microfluidic device are described in International Patent Application PCT/SE2004/01066 (Gyros AB).

All patents and patent applications cited in this specification are incorporated in their entirety by reference.

### BRIEF DESCRIPTION OF THE INVENTION

The present inventors have realized that it will be difficult and costly to construe microfluidic systems in which it is secured that the liquid handling always is taking place according to pre-programmed protocols. This applies to the dispensation of liquid to a microfluidic device as well as to the transportation of liquid within the individual microchannel structures of a device.

It thus is difficult to guarantee the quality of the performance of an experiment that will be or has been carried out within a microfluidic device. In the case the liquid handling fails, the result obtained will be unreliable and mostly should be discarded or in some instances allotted a low confidence.

It follows that the quality of an experiment based on the actual liquid handling could also be used in the determination of the confidence of the result obtained for the experiment, because inappropriate liquid handling usually lowers the confidence of the result.

It is an object of the present invention to present a method for assessment of the quality of the performance of an experiment that comprises one or more biological and/or chemical reactions in a microfluidic system.

It is another object of the present an invention to provide a method for liquid detection in one or more predetermined segments (liquid detection segments) of a microchannel structure of a microfluidic device in order to assess the quality performance of the liquid handling of an experiment carried out within a microchannel structure of a microfluidic device.

These objects are achieved by the method according to claim 1, and a system according to claim 22, and a computer program product according to claim 41 and a computer program according to claims 42.

Different variations of the invention is presented in the dependent claims.

One of the main characteristic features is to determine whether or not liquid and/or gas is present or absent in a selected segment of a used microchannel structure at the correct point of time.

One of the greatest advantages with the present invention is that unnecessary repetition of individual experiments due to failure in liquid handling can be minimized. This means that in stead of running replicates for large numbers experiments the present invention renders it simple to locate and flag those experimental results for which liquid handling has failed thereby making it simple to withdraw the result of these failure experiments from further consideration. This advantage will be greatest if the microfluidic device contains a plurality of microchannel structures as discussed below in combination with computer/software-based automation of liquid dispensation to and liquid transportation within the microchannel structures after initiation of a plurality of experiments in a plurality of the plurality of microchannel structures. Automation in the context typically extends to the detection and presentation of the results of the experiments and preferably includes the quality assessment of the performance of the experiments and flagging of at least the low quality experiments.

### BRIEF DESCRIPTION OF THE DRAWINGS

FIG. 1 is a block diagram depicting schematically a microfluidic system.

FIG. 2 shows an arrangement according to the invention in a microfluidic system.

FIG. 3 is a schematic picture of a microfluidic device in form of a disc.

FIG. 4 is a flowchart illustrating an embodiment of the present invented method.

FIG. 5 is an illustration of a preferred embodiment of the arrangement in a microfluidic system according to the invention.

FIG. 6 is a flowchart illustrating steps involved in a preferred embodiment of the invented method.

### DETAILED DESCRIPTION OF THE INVENTION

The present invention relates to microfluidic systems.

Different microfluidic systems are known. One type of systems comprises a controller unit and a microfluidic instrument. Such a system is called a Stand Alone System. Each system has its own data and operates completely stand alone. The interaction with the system may be performed at an associated Personal Computer (PC).

Another system can be considered as a group of instruments plus a common persistent storage location, e.g. database. Many instruments can operate on the same set of data (Method Data, Microfluidic Device Data, etc). All interactions with the system need to be performed at an instrument connected computer, a controller. This second system is often called a Distributed Database Solution.

In a third solution, the distributed solution, the system is considered as a group of instruments, a common storage persistent storage location (database), and a number of clients. With this solution the same functionality as in the above-mentioned Distributed Database Solution is reached. In addition there will be a possibility to interact with the system from noninstrument connected computers. Examples of additional provided functionality are:
Remote monitoring of instruments.
Perform functions that are not instrument specific (Method Development, Evaluation of processed data. Etc)

With this third solution it is possible to control (Start, Pause, Abort) the processing remotely, that is, from a non-instrument connected computer.

An operator/user can control and monitor the performance of the microfluidic instrument from the controller. The microfluidic instrument comprises of a number of different stations, each station being capable of performing one or a number of defined operations. Different types of microfluidic instruments consist of different kinds of stations or number of stations. Therefore, some operations will not be provided for or applicable on a certain type of microfluidic instrument.

The operations are initiated from the controller.

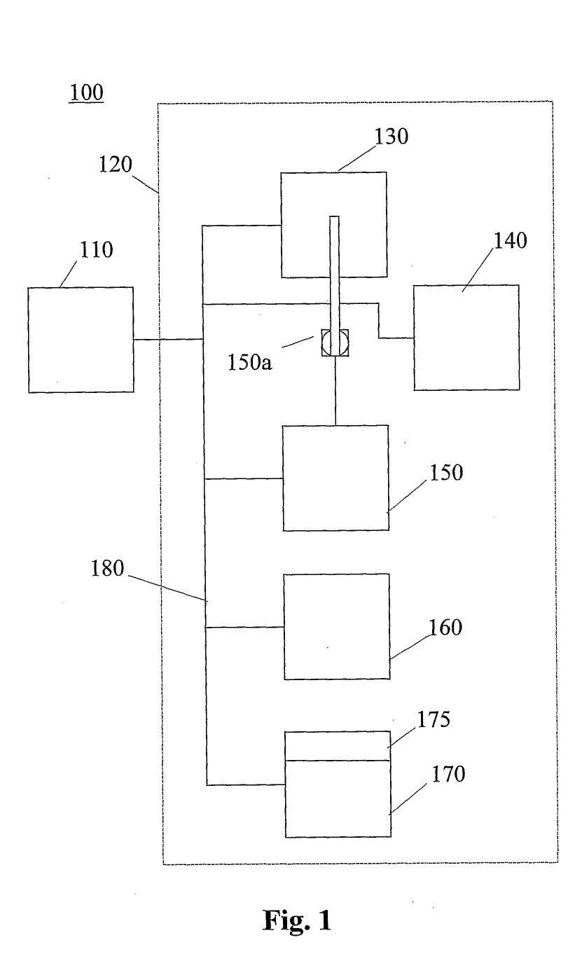

FIG. 1 is a block diagram depicting schematically a microfluidic system 100 that includes
a) a control unit, also denoted controller, 110, and
b) an instrument 120 comprising one or more of the following items:
   i) a sample and reagent station 130,
   ii) a wash station 140 for washing the liquid transfer or dispensation equipment,
   iii) a liquid transfer station 150 for transfer of liquid samples to a microfluidic device,
   iv) at least one station 160 for implementing transport of liquid within the microfluidic device e.g., a spinner station,
   v) a liquid detector station 175 for detecting the presence/absence of a liquid and/or a gas phase in a liquid detection segment as an indication of proper liquid handling in a microchannel structure containing the segment, and
   vi) a detector station 170, for collecting the signal reflecting the result of an experiment carried out in a microchannel structure of a microfluidic device via a detection area associated with the microchannel structure.

Some of the stations may be integrated with each other, for instance the liquid detector station 175 typically may be integrated with the station for implementing liquid transport within the device and/or with the detector station 170. An instrument according to the present invention at minimum comprises the liquid detector station 175 and the station for implementing liquid transport 160. For circular and/or rotatable microfluidic devices the liquid detector station 175 and/or the detector station 170 may incorporate a spinner/rotary function.

The signal collected in the detector station is typically radiation.

The controller 110 may be one or more computers outside the instrument and/or one or more central processors within the instrument. The controller is connected to the instrument 120 and its different stations via a conductor or data bus 180 and operation orders are typically transmitted either as electrical or optical signals or included in a suitable predetermined protocol to hardware circuits distributed between the stations.

A controller may comprise different control means, for instance electronic and programmable control means with operator's interface. Software, not further disclosed, may be assigned to a detector arrangement used for controlling
(i) detecting presence or absence of a liquid phase and/or a gas phase in liquid detector segments as discussed above, and/or
(ii) collecting signals representing the result of an experiment via the above-mentioned detection areas.

These control means may be used when
a) recognizing one or more pairs of start/stop-positions (angular and/or radial if the device is rotatable and/or circular) for irradiating if the detection principle utilized requires irradiation and/or for collecting the desired signal,
b) identifying individual subareas in detection areas or elsewhere in the surface of the disc, such as in the above-mentioned segments used for detecting failure in liquid handling,
c) controlling the movement of a microfluidic device and a detector head relative to each other, e.g. simultaneous rotating of the microfluidic device and incremental lateral/radial displacement of a detector head associated with any of the two detector arrangements discussed above (if the device is rotatable and/or circular),
d) collecting signal data from the detection areas/detection microcavities/liquid detection segments,
e) treatment and presentation of the collected data, and/or
f) determining the time at which a particular angular position is in front of the objective of a detector head from the rotational speed (if the device is rotatable).

Different parts of the instrument may communicate with the controller 110. The controller will in the preferred variants instruct a detector head to successively collect the signal from distinct and pre-selected parts of the surface of the disc if the detector station is according to US 20030054563 (Gyros AB), for instance. Typically the controller is programmed to start collecting signals at a position which is prior to an intended detection area/liquid detection segment, and to end the collecting at a position, which is after the same detection area/segment. If the collected signal requires irradiation, then the detector arrangement/head or some other means also should provide for such irradiation, which is the case if fluorescence, absorbance, reflection etc is measured. In this latter case the control means should also define the settings for the start and stop positions for irradiation. These latter settings are typically essentially the same as for collecting the signal.

The start and stop signals for collecting the signal representing the result of an experiment or the presence of liquid and/or gas in the liquid detection segment is preferably directly linked to positions in the microfluidic device at which collection of signal is to start and end, respectively. This also includes that due account is taken for delays that may be inherent in the system or preset, i.e., the start and stop signals may have to be initiated before the detector head is positioned in front of the start and stop position, respectively. If the microfluidic device is circular and/or rotatable, an angular aligning system within a spinner function may comprise an encoder, the encoder signals corresponding to a start position and a stop position are used to define the time period during which the signal is to be collected. In an alternative, the start and stop for collecting the signal is linked to a preset rotating speed, i.e., the controller calculates from a preset rotating speed the time at which the start and stop position should be in front of the detector head.

Further, the present system have a sample and reagent station 130 comprising means for storing samples, reagents or other liquids. Said samples, reagents or other liquids is stored in some kind of container, such as a micro plate or multiwell plate, a test tube rack or a test tube. Said plate is designed as a matrix of small containers or wells. Said plate can have different sizes depending on the number of wells. The container may be loosely fixed at a container holder, for instance a so-called carousel, which is a circular revolving plate.

The liquid transfer station 150 has a robot 150a that transfer at least one sample or any other predetermined liquid aliquot at a time from the sample and reagent station 130 to a microfluidic device, for instance in the form of a disc that can be spun. The station have means for transfer of liquid samples, and other liquids, for instance a number of injection needles connected to syringe pumps or a number of solid pins may be used for the transfer of samples. Said needles and pins may be configured in different numbers of rows and columns having different distance between the tips in both directions. Other alternatives have been discussed above under the heading “Background of the invention”.

Said needles and pins may or may not be washed in a wash solution between the transfers of samples and reagents. Washing is done by means placed in a wash station 140.

The liquids dispensed to a microfluidic device are transported within the device by means associated with the station 160 for implementing liquid transport. This station may be a spinner station in case the microfluidic device is adapted to permit liquid transport caused by spinning. The result of a process carried out within the microfluidic device is determined by means for detecting (a detector) which is located in a detector station 170.

The arrangement of the detector station 170 is adapted for measuring signals reflecting the result of an experiment. The signals are typically measured via a detection area in the surface of the microfluidic device and typically derive from an underlying detection microcavity which is part of a microchannel structure. A useful detector arrangement is described in US 20030054563 (Gyros AB) and comprises:
(a) a detector head with a focal area, and a disc holder which are linked to a means enabling for the detector head, i.e., the focal area to transverse, the surface of the disc when the disc is placed in the disc holder.
(b) an aligning system for recognizing the position of the part area which at a particular time is covered by the focal area, the aligning system comprises for circular and/or rotatable microfluidic discs one part for angular alignment and an optional radial aligning system for recognizing the radial position of the part area which at a particular time is covered by the focal area, and
(c) a controller, e.g., computer with software, which controls
   (i) equipment causing the focal area to transverse a zone containing the detection areas of a microfluidic disc/device, e.g. in an annular zone of a circular and/or rotatable disc, and
   (ii) the detector head successively collects signals in a preselected manner from individual subareas of essentially the same size as the focal area within at least one of the detection areas in said zone.

As shown in FIG. 1, each of said stations is connected to the controller 110 and controlled and monitored from the controller 110 by means of a number of operations. A software operation is defined as a logical group of hardware instructions, which are performed to accomplish a certain function, such as:
Implementing transport of liquid, for instance spinning the device if the device is in the form of a disc that can be spun in order to induce liquid flow.
Sample transfer to a specific common distribution channel or a specific microstructure.
Reagent transfer to a specific common distribution channel or a specific microstructure.
Position the microfluidic device.
Incubate the liquids at a certain position in the microstructures for a specific time.
Detection, i.e. detection of the results of the method carried out in the microfluidic device, or of the presence and/or the absence of a liquid phase and/or a gas phase in one or more preselected liquid detection segments as discussed above.

An operation may consist of a number of steps. A step is a non-dividable instruction, such as a ramp in a spin operation. A set can be constituted by putting together a number of these operations in a desired order. Such a set is defined as a method and controls all parts conducted within the instrument. It prescribes a type of microfluidic device and defines a set of actions, operations. It may prescribe halting for conducting steps outside the instrument, for instance incubations at constant temperature when the method concerns cell culturing.

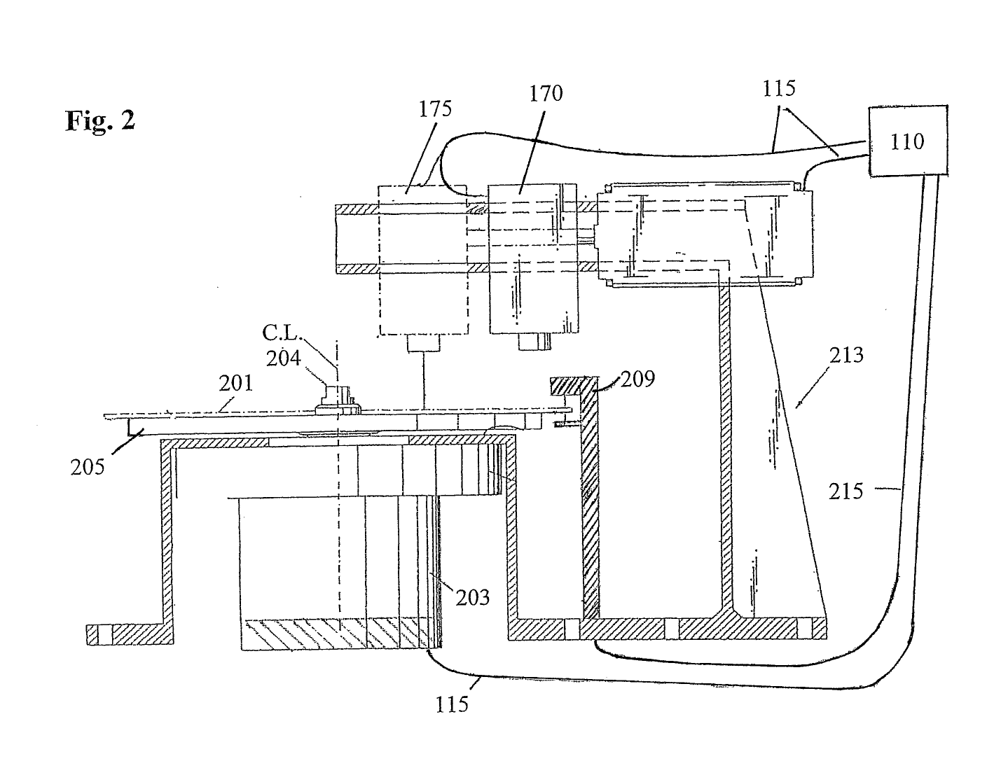

FIG. 2 shows a liquid detector station arranged with a spinner function in a microfluidic system according to the invention (rotatable microfluidic device). In a typical variant, a motor 203 (e.g., a spinner) with a rotatable shaft 204 carrying a disc holder 205 are supported on a frame structure 213. The motor 203 controls the rotating speed that can be varied, e.g., within an interval between 0-15,000 rpm, such as above 60 rpm. The rotation of the disc 201 may be stepwise. The disc holder 205 is preferably a plate on which the disc can be placed. The disc holder could also be a device that holds the disc at its periphery. In preferred variants the disc is retained on the holder by vacuum applied via the side of the plate facing the disc. See for instance US 20030082075 (Gyros AB) and US 20030064004 (Gyros AB). Depending on the principle used for detecting liquid/gas in a liquid detection segment, the liquid detector station may comprise a sensor unit 175, e.g. a liquid detector head (detection principle based on radiation) or a sensor (not shown) (detection principle based on conductivity etc) physically in direct contact with the liquid detection segment.

In principle any kind of detection principle that is capable of a) discriminating between a liquid phase and a gas phase and/or b) detecting a liquid meniscus in a microchannel can be used. In the context of the present invention the term “meniscus” includes any kind of interface between a gas phase and a liquid phase within the microfluidic device. Typical detection principles are based on differences between a liquid phase and a gas phase, e.g. in conductivity, absorbency or scattering of invisible or visible light or some other irradiation, emission of light, a difference in refractive indices etc. See for instance U.S. Pat. No. 6,444,173 (Orchid) (difference in conductivity), U.S. Pat. No. 6,774,616 (Eppendorf & Agilent) (refractive indices), WO 03102559 (Gyros AB) (surface plasmon resonance/refractive indices) and possibly many others. The most attractive way is an image detector device for imaging one or more liquid detection segments of one or more microchannel structures at a time. Other alternatives are by visual inspection possibly combined with magnification of the relevant liquid detection segments of the microchannels structures. The above-mentioned differences can be enhanced by addition of suitable agents such as salts, light absorbing solutes, fluorescent solutes, particles etc with due account taken that the agents used should not disturb the experiment as such or the measurement of the result of the experiment.

In the system described in WO 031002559 (Gyros AB) the same principle is used for measuring the result of the experiment from a detection microcavity as used for detecting the presence/absence of liquid and/or gas in a liquid detection segment. The system illustrates the possibility for highly integrating the detector station 170 with the sensor unit 175 of the liquid detector station.

The image detecting/registering step can be carried out both with detector head devices in a sensor unit that are able to directly generate images in a digital format, starting from the light radiation incident on the detecting elements (digital video cameras, webcams, etc.) and with analog detecting devices in the sensor unit (e.g. television cameras or video cameras), associated with appropriate converters capable of obtaining images in a digital format by processing corresponding images of analogue type. The image detection can be carried out by means of C-MOS devices that, with respect to other technologies, have reduced production costs, the possibility of integrating all functions necessary to the television camera into the same chip, low consumptions, high dynamics and high acquisition velocity. The liquid detector head device should have relatively high resolution.

The liquid detector station is also associated with a controller function that is part of the controller 110 of the system. This controller function may be used for one or more of the following tasks:
1) Controlling the alignment with and/or measurement in a particular microchannel segment at a predetermined stage of an experimental protocol. The predetermined stage may be immediately before, during or after liquid has entered the segment from an upstream location and/or before, during or after liquid transport has been implemented from the segment.
2) Relating the result of the measurement (presence or absence of a liquid phase/gas phase and/or a liquid meniscus in the segment) to what is expected from the protocol of the experiment.
3) Flagging experiments as low quality experiments if the liquid handling has failed for them. This part of the control function may also include that the result of the experiment concerned is discarded and/or allotted a low confidence.

The system also has to contain a position device (denoted as 209 in FIG. 2) for determining when a predetermined position of the microfluidic device or disc is in front of a needle or a detector objective. Different position devices are known in the market. For rotatable microfluidic devices there are encoders, absolute position encoders etc. A simple but less accurate alternative is to include calculating means that calculates the time needed from a preset rotation speed and the angular distance between the predetermined position and a home position mark (i.e., from the preset rotation speed and the angular position co-ordinate). This kind of calculating means may be associated with the controller. For rectangular non-rotating microfluidic devices conventional X-Y positioning devices can be used.

The use of the above-mentioned kind of positioning devices for dispensing of liquids, detection of radiation from detection areas etc in rotatable microfluidic devices has been utilized in Gyrolab Workstation (Gyros AB, Uppsala Sweden). See for instance US 20030094502 (Gyros AB), 20030054563 (Gyros AB). Alternative variants utilizing detector heads and dispensing heads with positioning functions combined with labeled detector areas and labeled inlet ports for liquid have been described in U.S. Pat. No. 6,338,820 (Alexion) and WO 9609548 (University of Glasgow).

An absolute encoder is a position device that progressively gives the angular distance from the home position mark while the disc is rotating.

The position device 209 in FIG. 2 is typically associated with the motor 203, the shaft 204, and the disc holder 205 and connected to a position controlling means of the controller. By associating the position device directly with the disc 201 it is likely that the most accurate determination of positions will be accomplished. This kind of position device typically divides each revolution of the shaft into a large number of grades, denoted as resolution grades, for instance >5 000, such as >10 000 or >20 000 or >30 000. The position device should be able to give the angular position coordinate for the part of the disc which is in front of a home position mark detector with an accuracy and resolution of ±1°, such as within ±0.1° or within ±0.01° (provided there are 360° per revolution). The exact accuracy needed will depend on the size of the disc, radial position of the detection area, the required sensitivity, size of detection area, etc

The position controlling means 220 of the controller 110 will receive or transmit different data using a position signal P over the connection 215 depending on the type of position device 209. If the position device is an encoder generating a pulse for each resolution grade, the position controlling means involves a pulse counter for registering the pulse sum value that is representing the current position of the disc relative to a start position or the home position, and the detector. If the position device is an absolute encoder, the position controlling means will receive or transmit an absolute measure of the angular distance from a start position or the home position. In either case, the position controlling means of the controller is able to control the position device. The position controlling means sets a desired position and transfer the desired value to the position device, which receives the position and controls the motor 203, the shaft 204, and the disc holder 205 to set the disc in the desired position.

What has been said above about the position device of a liquid detector head applies, where appropriate, also to the detector head of the detector station 170, to the liquid transfer station 150 etc.

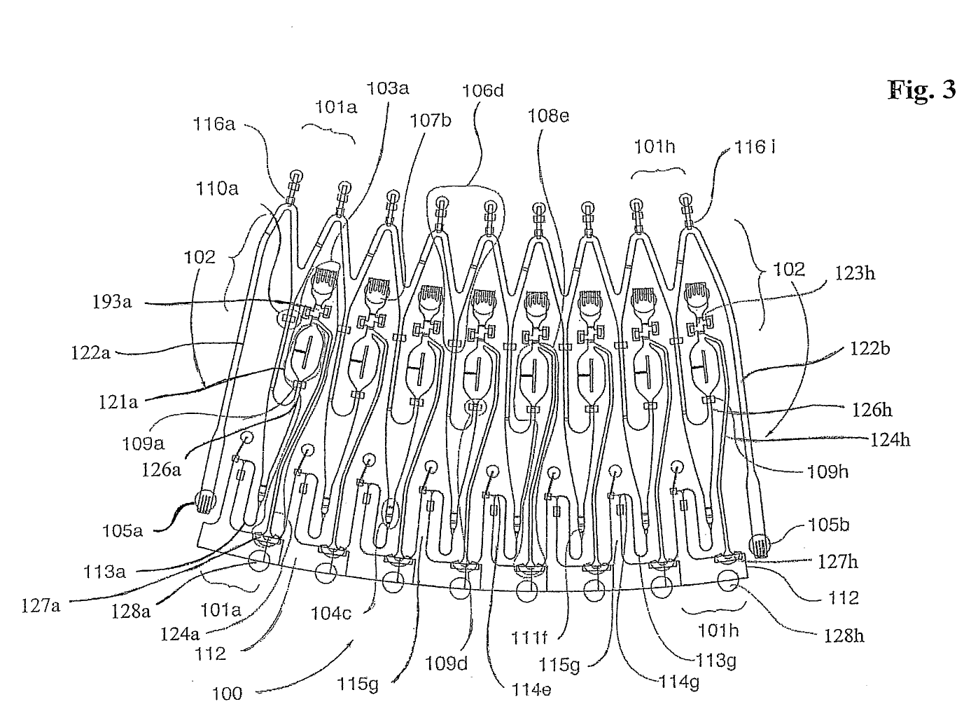

FIG. 3 shows a subset of microchannel structures of a microfluidic device that can be used in the various aspects of the invention. Each device comprises a plurality of microchannel structures in which aliquots (=droplets) of liquids are transported and/or processed. Plurality in this context means ≧5, such as ≧25 or ≧50 or ≧100 microchannel structures per device. The upper limit may be 200, such as 400 or 1000 microchannel structures per device.

The devices typically are disc-shaped with the microchannel structures oriented in one or more planes. The structures are enclosed in the sense that their interior is in contact with ambient atmosphere via separate inlet and/or outlet openings and/or vents.

A microchannel structure (each of 101a-h) of a microfluidic device comprises in the downstream direction:

a) an inlet function (102+105a+105b+103a for structure 101a),
b) a reaction microcavity (104a),
c) a detection microcavity (104a), and
d) an outlet function (113a+115a+112).

The inlet function (102+105a+105b+103a) is needed for the introduction of liquid into a microchannel structure (e.g. 101a). The inlet function primarily comprises one or more physically separated inlet arrangements (IA) each of which contains at least one inlet port, and typically also one or more volume-defining units (each of 108a-h or 102) which each comprises (for microchannel structure (101a)):
i) at least one volume-metering microcavity (121a, 106a,),
ii) at least one inlet microconduit (122a-b, 123a) that in the in the upstream direction is communicating with an inlet port (105a-b, 107a) and in the downstream direction with a volume-metering microcavity (121a, 106a,),
iii) an outlet microconduit (122a-b, 126a) connected to the outlet end of a volume-metering microcavity, and
iv) typically also a microconduit (122a-b, 124a) for draining excess liquid to a waste function (overflow microconduit=excess microconduit).

FIG. 3 illustrates two kinds of inlet arrangements (IAs). The first kind (e.g. 103a) comprises a volume-defining unit (e.g. 108a) that has the subunits i-iv (121a, 123a, 126a, 124a, respectively) and communicates in the downstream direction with only one microchannel structure (101a) and in the upstream direction with only one inlet port (107a). The second kind (102) is common to several microchannel structures (101a-h). It comprises a volume-defining unit (102) with eight volume-metering microcavities (106a-h) which each has an outlet microconduit (126a-h, respectively) which in the downstream direction is communicating with a microchannel structure (101a-h, respectively) and in the upstream direction with one, two or more inlet microconduits (122a-b) that are common to all of the volume-metering microcavities (106a-h). As illustrated in FIG. 3, an inlet microconduit (122a-b) of a volume-defining unit may have a dual function in the sense that it also can function as an overflow microconduit for at last one volume-metering microcavity (106a-h) (=overflow microconduits for the volume-defining unit (102)). A volume-defining unit (102) that is common to several microchannel structures (101a-h) is also called a distribution manifold.

Each microchannel structure comprises one or more reaction microcavities (104) (=reaction zone) and possibly also one or more detection microcavities (104) (=detection zone), and microconduits connecting these parts with each other. Structural units of various kinds may interrupt the reaction zone and also the detection zone of a microchannel structure. Thus the first reaction microcavity of the reaction zone may be followed by a detection microcavity that in turn is followed by a second reaction microcavity. The reactions are typically chemical and/or biological. Detection of the result of the experiment and/or of one or more of the reactions of an experiment is typically determined from signals collected (below also called physical parameter values) from a detection microcavity as discussed elsewhere in this specification. FIG. 3 illustrates that a reaction microcavity (104) may coincide with a detection microcavity (104). In other variants the reaction microcavity may typically be located upstream a detection microcavity (not shown).

The outlet function of a microchannel structure (101a) typically comprises one or more outlet arrangement (OA) which each contains at least one outlet port (128a) that vents over-pressure, if ever created during liquid transport, to ambient atmosphere. In many cases an outlet port also functions as an outlet for liquid that has passed through the structure. An outlet arrangement typically also contains an outlet microconduit (113a) from the most downstream microcavity (104a), and possibly also a waste function comprising the outlet port, a waste microconduit (115a-h) and/or a waste chamber (112) etc. As illustrated in FIG. 3, the outlet arrangement (OA) may or may not comprise parts that are common (112, 128a-h) to several microchannel structures (101a-h) or only part (113a,115a) of one such structure (101a).

The transport of liquid aliquots (droplets) within a microchannel structure of a microfluidic device is typically driven in various ways, for instance by electro-kinetic and/or non-electrokinetic forces. The latter forces encompass capillary force, inertia force such as centrifugal force, hydrostatic force etc. Within a microchannel structure the transport of a liquid aliquot may be halted at valves that may be closing or non-closing. Closing valves may be mechanical by which is meant that the liquid transport is stopped by physically closing the microconduit comprising the valve. In non-closing valves the transport of the liquid aliquot stops without closing the microconduit. Typically non-closing valves are so called capillary valves in which a liquid front advancing in a hydrophilic microconduit is halted at an abrupt increase in cross-sectional dimension and/or at a hydrophobic surface break of the microconduit. By increasing the force driving the transport, the liquid aliquot passes the valve and the transport is resumed. The terms “non-closing” and “closing” valves have been defined in WO 02074438 (Gyros AB). Valve functions in microchannel structures are typically included in association with an outlet of a microcavity, a microconduit and the like. In FIG. 3, valves (110a-h, 109a-h, 127a-h) are indicated at the outlet of each volume-metering microcavity (106a-h, 121a-h) and overflow microconduits (127a-h). Valves may also be present within and or at the inlet or outlets of microconduits of other kinds and/or at the outlets of other kinds of microcavities, for instance so called retaining microcavities including mixing microcavities, detection microcavities, reaction microcavities, collecting microcavities, premixing microcavities, liquid storing microcavities etc. See for instance WO 02075775 (Gyros AB), WO 02074438 (Gyros AB), WO 02075312 (Gyros AB), WO 03018198 (Gyros AB), WO 03025498, U.S. Ser. No. 60/557,850 (Gyros AB), GY 60/508,508 (Gyros AB), the corresponding regular application filed on Oct. 1, 2004, PCT/SE2004/001424 (Gyros AB), PCT/SE 2004/000795 (Gyros AB), and the corresponding non-provisional application filed on May 19, 2004 (Gyros AB) etc.

Microconduits, microcavities, inlet port, outlet ports, distribution manifolds, waste microconduits etc that are common to several microchannel structures are part of all the microchannel structures they are common for.

The terms “microchannel”, “microconduit”, etc., contemplate that a channel structure comprises one or more cavities and/or channels/conduits that have a cross-sectional dimension that is ≦10³, m, preferably ≦10² μm (depth and/or width). The volumes of microcavities/microchambers are typically ≦5000 nl, such as ≦1000 nl or ≦500 nl or ≦100 nl or ≦50 nl or ≦25 nl, which in particular applies to the detection microcavities. Microformat means that one, two, three or more liquid aliquots that are transported within the device have a volume in the μl-range, i.e., ≦5000 μl such as ≦1000 μl or ≦100 μl or ≦50 μl including but not limited to the nl-range (nanoformat), such as ≦1000 nl or ≦500 nl or ≦100 μl or ≦50 nl.

The experiment carried out in a microchannel structure typically comprises the steps of:
1. introducing one or more liquid aliquots (aliquot₁, aliquot₂ etc) into the inlet function (102+105a+105b+103), and
2. transporting and processing said one or more aliquots within a microchannel structure (101a),
3. determining the result of the experiment in a detection microcavity (104).

Processing contemplates that one or more chemical and/or biological reactions are carried out in at least one reaction microcavity (104) as defined elsewhere in this specification. The liquid handling (steps (1) and (2)) typically comprises that one or more liquid aliquots of different and/or equal volume(s) and/or composition(s) are introduced at the same and/or at different stages of an experiment. During the transport and processing one or more of the aliquots may be transformed to aliquots that have other volumes and/or other compositions. This typically means that a liquid aliquot (aliquot 1) is dispensed to an inlet opening of a microchannel structure and transported downstream, for instance to a first valve position where it is halted and processed, for instance by separating it into one or more defined subparts (sub-aliquots 1, 2 . . . ) by the use of a volume-defining unit/distribution manifold as discussed above. The part volume(s) (sub-aliquots(s) may then be transported further downstream, for instance into the microchannel structure(s) linked to the volume-defining unit with one part volume to each microchannel structure. Further transport in a microchannel structure may mean halting of the transport at a valve position at an outlet end of a liquid retaining microcavity or retardation of the transport by so called restriction means in or downstream a microcavity as discussed elsewhere in this specification. Each time the transport of an aliquot is halted, it will be possible to observe a fixed upper (upstream) meniscus and if halting is at a non-closing valve also a lower (downstream) meniscus. The presence and/or absence of a meniscus can be used as an indication of failure or success of the liquid transport to and/or from the structural unit at which the halting is taking place. Since these transport pauses are controlled by the process protocol of an experiment the presence and/or absence of the meniscus will also be indicative of the success or failure of the performance of the experiment. This does not exclude that the presence/absence as such of liquid is detected and used as an indication of the quality of the performance the experiment as discussed herein.

Thus the liquid detection segment discussed above typically encompasses structural units, including microcavities and microconduits, ending with a valve. Typical examples are liquid retaining microcavities, microconduits in which liquid is to be retained, etc. More specific examples are mixing microcavities, detection microcavities, reaction microcavities, overflow microconduits, volume-metering microcavities, distribution manifolds, outlet microconduits, such as from various kinds of microcavities discussed above and/or to ports to ambient atmosphere (for instance sole gas outlet ports (vents) or combined liquid and over-pressure outlet ports. See above and WO 02075775 (Gyros AB), WO 02074438 (Gyros AB), WO 02075312 (Gyros AB), WO 03018198 (Gyros AB), WO 03025498, U.S. Ser. No. 60/557,850 (Gyros AB), GY 60/508,508 (Gyros AB), the corresponding regular application filed on Oct. 1, 2004, PCT/SE2004/001424 (Gyros AB), PCT/SE 2004/000795 (Gyros AB), and the corresponding non-provisional application filed on May 19, 2004 (Gyros AB) etc.

In some variants of the invention the transport as such of the aliquot is detected, for instance as the movement of a meniscus, and taken as an indication of the presence and/or absence of a gas phase or liquid phase. The rate at which transport is taking place may in some variants be compared with the transport rate that should be at hand according to the experimental protocol carried out. A deviation may then be used as a variable in the assessment of the quality performance of the experiment and/or the determination of the confidence of the result. Detection of the transport as such may be used in liquid transport microconduits, reaction microconduits and in reaction microcavities in which a reaction is taking place between a solid phase that is retained in the conduit/cavity and possibly contains an immobilized reactant. In this latter case the solid phase as such may cause a restriction resulting in a retardation of flow. Alternatively the reaction microconduit/microcavity acts as a restriction microconduit or is directly linked to a restriction microconduit in its outlet end. Restriction microconduits are typically more narrow and/or longer than the microconduit/microcavity part containing the liquid aliquot before its entrance into the restriction microconduit or contains restriction means such as porous beds, membranes or raised portions. The porous bed may be the solid phase discussed above. Restriction microconduits and means causing flow retardation (restriction means) are discussed in detail in GY 02075312 (Gyros AB) and WO 03018198 (Gyros AB).

The presence/absence of a gas phase/liquid phase in a structural unit as well as filing and/or emptying or liquid transport in a structural unit can thus be followed in real time. A comparison can be made with the desired time at which structural unit should have contained the liquid phase or gas phase according to the actual protocol of the experiment. An abnormal deviation will mean that the filling/emptying/transport has not taken place properly in the microchannel structure, in particular not in the part of the structure associated with the liquid detection segment at issue. This also means that the performance of the experiment has failed and thus has a lower quality compared to an experiment in which such a deviation is not at hand. This kind of information may also be used for the determination of the confidence level of the result, i.e. to allot a confidence level to the result, e.g. zero in the case the deviation is unacceptable (failure experiment). The experiment may thus be assessed as a low quality experiment and/or a failure. This makes it possible to allotting a low confidence to the result of the experiment and/or to simply discard the result obtained. Similarly if a deviation is acceptable and/or non-detectable, a high quality can be assessed for the liquid handling during the experiment and consequently a high confidence (e.g. the value 1 on a scale 0-1) of the results obtained (if not other confidence variables pointing at a low confidence take precedence).

The significance of a found deviation in the liquid handling will depend among others on the kind of liquid transported, such as
a) wash liquids,
b) conditioning liquids,
c) diluents for diluting a liquid containing one or more reactants,
d) liquids containing one or more reactants used for carrying out the reactions of the experiment concerned, etc.

Reactants include analytes and reagents. Thus the aliquot detected in a liquid detection segment may be selected amongst a wash aliquot, a conditioning aliquot, a diluent aliquot, an aliquot containing a reactant, such as an analyte (aliquot=an analyte sample) or a reagent (aliquot=reagent sample).

The controller 110 of the microfluidic system has to be able to control and manoeuvre aforementioned needles, pins or detector head to said inlet ports, cavities, segments etc with an accuracy of a few μm. The controller has to have the exact position data for different inlet ports, outlet ports, vents, detection positions, etc., of each disc type using the correct home position. Said position data may be stored and possible for the controller to retrieve from the storage, alternatively, the controller may be programmed to calculate the position data. It is therefore often important to find the correct home position mark on a disc with high accuracy.

The controller also is capable of controlling the transport of the liquid aliquots within each of the microchannel structures of the microfluidic device that is processed. Process parameters such as sequences of steps and times for initiation and stops of various process steps as well as application of suitable driving forces for liquid transport etc are retrievable by the controller from a data storage medium connected to the controller. This includes also times when it is appropriate to check for the presence and/or absence of a liquid phase and/or a gas phase in a liquid detector segment, such as a liquid-gas interface (meniscus).

A method for finding the correct home position mark and determining the accurate home position on the current disc laying on the disc holder is earlier described in WO 03087779 (Gyros AB). Said process is often denoted as the “homing process”.

The term “physical parameter value” will in a generalized manner refer to the magnitude (including absence or presence) of the signal that is measured according to the detection principle used for detecting if a liquid and/or a gas phase is present in a liquid detection segment.

Physical parameter values for different parts or points of a liquid detector segment of a microchannel structure are stored in a segment indicator in the appropriate data storage medium, such as a computer based storage medium. There is typically one specific segment indicator for each liquid detector segment of each microchannel structure of a microfluidic device to be processed. Physical parameters and segment indicators will be described in more detail below.

In the following, various variants of the method according to the invention for liquid detection in a microchannel structure by means of a sensor unit 175 comprising an image detector unit, as in FIG. 2, will be described. The microfluidic device is circular with microchannel structures as given in FIG. 3. In accordance with the invention, when performing liquid detection within at least one segment of each microchannel structure, i.e. detecting the presence or absence of liquid and/or gas during a period of time for which it is known if liquid and/or gas shall be present in a segment, a dedicated segment indicator for said segment is changed. Each segment indicator may be processed by itself or processed in a group, included in an Indicator matrix comprising all or only a number of segment indicators of a microfluidic device. The dimension of an indicator matrix corresponds to and is defined by a masking filter, defining the position and geometric dimensions of each liquid detector segment of each microchannel structure of the microfluidic device. The resolution of the segment indicator depends on the resolution of the detection unit. The segment indicator may be represented as a matrix comprising a number of physical parameter values (one value for each point of resolution, e.g. pixel), a vector matrix, i.e. a column matrix or a raw matrix, of physical parameter values, or one single parameter value (e.g. the value measured in one point or pixel). Depending on which method that is used for determining the absence and/or presence of liquid and/or gas usually a number of segment indicators of the same segment and hence a number of indicator matrixes, one indicator matrix for each liquid and sub-run, are generated. The segment indicator may also be represented by one physical parameter or a number of different physical parameters. The segment indication parameter will therefore depends on the liquid detection method. For example, different physical and detectable intensities may be chosen as indicator parameters. If an image detecting unit is used, it is possible to select pixel intensity as an indicator parameter.

All Indicator matrixes are analyzed by computer means, software program in combination with digital processing means such as a data processor, computer, microprocessor, Central Processor Unit (CPU), neural network etc. The digital processing means is programmed to analyze each segment indicator in the matrix indicator and depending on the degree of change in a segment indicator, the digital processing means is programmed to be capable of setting a graded confidence value by means of the confidence determination means implemented as instruction steps in a software program. Said digital processing means may be implemented as a free-standing unit or included in the controller 110.

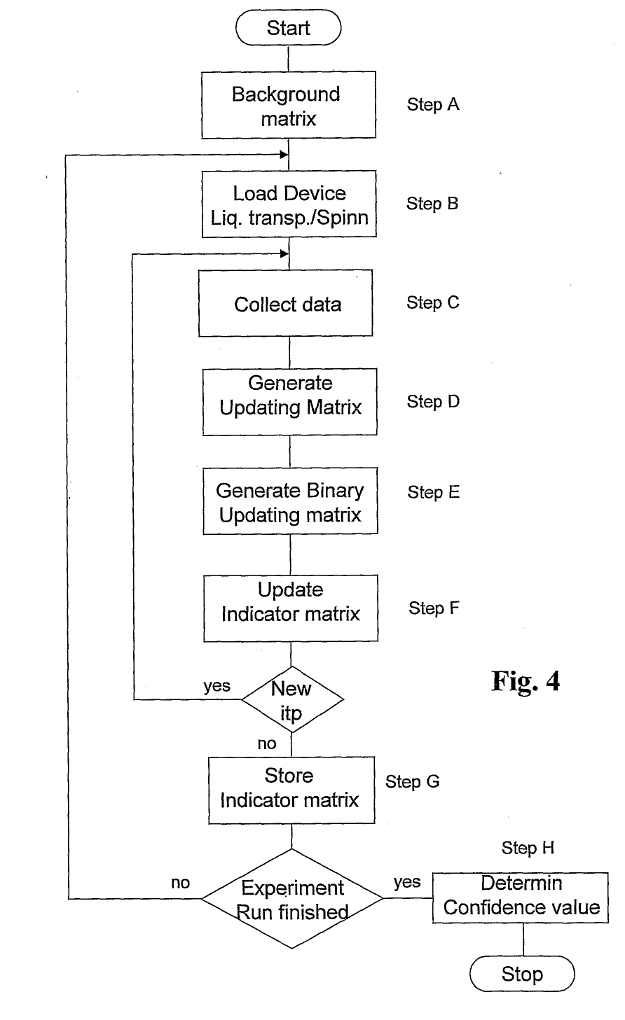

The steps of the invented method will now be described in more detail by reference to the flowchart in FIG. 4. The first step, step A, is to collect, acquire, information (physical parameter values) from the unloaded microfluidic component by means of an image detector unit and an eventual illumination unit, i.e. in this case imaging and recording a background image of the whole or a part of the unloaded microfluidic device in its home position, nₚ=0, and transform the background image into a background matrix. The background image is a digital image, comprising pixel and pixel values, e.g. pixel intensity, which is then stored in an image memory, which is a data storage designated for storing image and matrix digital data/information. The background image will contain the background information, such as e.g. background intensity, background noise, etc., which will be present in all the following images of the same microfluidic devices during the experiment run.

In the following description, intensity (measured or detected in a pixel/point) is chosen as example of a physical parameter. However, this should not be regarded as a limitation as other physical parameters are applicable in the invented method. An optional step, step ab, for identifying the microfluidic device may have to be performed. Microfluidic disc characteristic data may already be prepared by the manufacturer and involve number of microchannel structures and their positions on the microfluidic device in relation to the home mark or a line between the home mark and another position, e.g. the axis of rotation for a circular microfluidic disc. The positions of the inlet port of each microchannel structure may also be provided or possible to determine by calculation. Said characteristic data contain information regarding the design of the microchannel structures, either dimension data, angular data, curvature data, etc of the different parts of the microchannel structure or an identification name referring to a table with said parts and their dimension data, angular data, curvature data etc. The characteristic data or identifying name may be used for identifying a corresponding masking filter that will define at least one segment of each microchannel structure of the microfluidic device and the corresponding segment indicator(s). The masking filter is preferably implemented as a computer program software, which is capable of handling matrix algorithms and matrix processing, when inserted in a data processing means (computer and similar), such as the controller (110).

The background image is processed with the masking filter described above which generate a background matrix. The background matrix will only contain the intensity value of each pixel for each liquid detection segment of a microfluidic device. A segment pixel is a pixel belonging to an image area within a segment of a microchannel. The masking filter also defines the shape, size and position of each segment in an image of a microfluidic device. In the device containing the microchannel structure defined in FIG. 3 this will typically means that liquid detection segments are defined for at least certain parts of the volume-defining units (108a-h; 102) in particular encompassing the valve positions (109a-h and/or 127a-h; 110a-h) and/or the volume-metering microcavities (121a-h; 106a-h) and possibly also for the volume immediately upstream the detection/reaction zone (104a-h) and/or the restriction microconduit (113a-h). The masking filter has a sorting function that will distribute the detected information into the correct address of the used matrix. The masking filter will delete all unnecessary information outside the segments, i.e. in this example all pixel values outside the segments of the microchannel structure.

The next step, step B, comprises introducing a liquid aliquot containing a reactant or a wash or a conditioning liquid into a predetermined inlet port (each of 107a-h or 105a or b,) of each of the decided microchannel structures (110a-h) involved in the “experiment run” of one microfluidic device and transporting the front of the liquid aliquots to the first valve positions (109a-h+127a-h or 110a-h). No centrifugal force or other active forces are needed, since devices of the type represented in FIG. 3 and manufactured by applicant have inner surfaces with a wettability permitting filling each of the microchannel structures up to these valve positions passively by self-suction. The next step, step C, is logically to collect, acquire, information from the loaded (with liquid aliquot of reagent or wash solution) microfluidic component by means of the detector unit and the eventual illumination unit, i.e. in this case scan, detect and record an image of the whole or a part of the loaded microfluidic device in its home position, nₚ=0, and transform the image into an image matrix by means of the masking filter defining liquid detection segments as discussed above.

A lap counter will record each pulse from the home mark detector when the home position mark that is present on the circular microfluidic device passes. The lap counter and/or the controller is able to generate an Image Trigger Pulse (itp) to the detector unit, such as an camera, each time the lap sum lₛᵤₘ equals a preset image trigger value L_{trig}. Said image trigger value L_{trig} may be preset to any suitable integer L_{trig}=1, 2, 3, 4, 5 . . . . The camera will register an image of the surface of the whole microfluidic device for each image trigger pulse. When the lap counter generates the trigger pulse, it will also reset the current lap sum lₛᵤₘ to zero.

Each time the camera registers an image, the image will be processed with the mask filter generating an image matrix and excluding unnecessary pixels and pixel information, focusing on the segments.

The point of time at which the camera registers an image is controlled by the controller using protocol information stored in a data storage memory, where appropriate in combination with the preset image trigger value L_{trig}. In step D, all the segments of the current image matrix will be processed with the segments of the corresponding segments of the background matrix resulting in a difference matrix, hereafter denoted as an updating matrix containing the updating information for each segment and segment indicator. For example, each pixel intensity value of a segment (segment indicator) in an image matrix that has been changed and differs from the pixel intensity value of the corresponding pixel in the background matrix more than a predefined threshold intensity will result in an absolute intensity value (always positive) that differs from zero in the updating matrix.

In step E, a binary updating matrix is generated by processing the segment indicators of the updating matrix by using a binary filter transforming the non-zero pixel intensity values to a binary “1” if the intensity value exceeds a predetermined threshold Intensity value corresponding to an acceptable intensity variation between images recorded sequentially in time. This transform operation will allow an intensity variation depending on other reasons than a detected liquid aliquot passing the segment and causing an intensity change in at least one segment pixel.

In the next step, step F, the binary values of the segment indicators of the binary updating matrix is combined with the corresponding (in the same address or position) binary values of an indicator matrix generated of the previous image, if any, by a modulo-2-addition operation which generates a new indicator matrix. In the first lap, all pixel values is preset to binary “0”.

When a sub-run of the experiment is finished, no new trigger or itp will be generated, and the controller will perform step G, storing of the indicator matrix, which is a result of the sub-run. If the whole experiment run is finished (yes), the controller will start, step H, the determination and grading of the confidence value by use of all the stored Indicator matrixes, each one related to a specific sub-run of the experiment run.

Depending on type of inlet port(s) used, the initially introduced liquid aliquot(s) will fill up I) the distribution manifold (102), or II) each of the volume-defining unities (108a-h).

In variant I) further transport is taken place by
a) first spinning the disc at a speed adapted to a centrifugal force that is sufficient for forcing excess liquid in the two combined overflow/inlet microconduits (122a,b) out through the two combined inlet/outlet ports (105a,b) but insufficient for causing emptying of the volume-metering microcavities (106a-h) through the outlet valves (110a-h), and then
b) increasing the spinning to a speed, for instance by a short pulse, that is sufficient for forcing the liquid in the volume-metering microcavities (106a-h) out through the outlet valves (109a-h).

At the end of this 2-step procedure a liquid aliquot is layered on top of the porous bed in the reaction microcavities (104a-h).

Variant II similarly comprises two steps a) emptying of the overflow microconduits (124a-h) followed by emptying of the volume-metering microcavities (121a-h). Also in this variant the liquid in the volume-metering microcavity is layered on top of the porous bed of the reaction microcavities (104a-h).

Finally the spinning speed is adapted such that the liquid aliquot layered on top of each reaction microcavity/porous bed (104a-h) is passed through the beds at a predetermined rate and out through the restriction microconduits (113a-h).

Images are recorded, step (C), each time a liquid aliquot has stopped at the valve position(s), slowed down at the porous bed, or passed through the restriction microconduit passed (=liquid detector segments). For each image a new updating matrix is generated, step D, a binary updating matrix is generated from the updating matrix, step E, and the new updating matrix is combined, in step F, with the previous indicator matrix from the previous image through a modulo-2 addition leaving the binary “1” unchanged and changing a binary “0” to “1” if the updating matrix has a “1” in the corresponding segment pixel position. This is necessary, as the liquid aliquot may only pass the segment without staying in the segment and the intensity value of the pixels belonging to the segment therefore will return to the intensity value of the background image or very close to said intensity value. As the binary “1” remains in the indicator matrix, said binary “1” in the pixels positions of a segment will indicate that the liquid aliquot at least passed the segment.

When a sub-run of the experiment is finished, no new trigger or itp will be generated, and the controller will perform step G, storing of the indicator matrix, which is a result of the sub-run. If the whole experiment run is finished (yes), the controller will start, step H, the determination and grading of the confidence value by use of all the stored Indicator matrixes, each one related to a specific sub-run of the experiment run.

Each experiment run usually comprises a number of sub-runs, each different sub-run involving the loading/dispensing of a predetermined liquid, e.g. a reagent, wash solution, etc. When the run, i.e. the experiment, is stopped, all indicator matrixes are analyzed by a confidence determination means in the confidence determination step, step H. A stored point/pixel value of a segment indicator may be processed by modulo-2-addition of the corresponding point/pixel values of the segment indicators of the corresponding stored Indicator matrixes of each sub-run to a final value of a final segment indicator of a final Indicator matrix (point/pixel value means the value, binary, digital, or parameter value, detected and/or determined in a specific pixel or point). If all point/pixel positions in the indicator matrix contain a binary “1”, the run was successful, and the confidence determination means generate a confidence value set to “1” for that sample. If pixel positions corresponding to a segment only contain binary “0”, or a clear minority of binary pixel values “1”, the aliquot did not pass said microchannel segment, properly. In the binary “0” case, the performance of the experiment carried out in the corresponding microchannel structure is assessed a lower quality compared to an experiment/microchannel structure for which a binary “1” has been obtained for all pixel positions in the indicator matrix. The confidence value for the result of binary “0” experiment is lowered compared to a binary “1” experiment, and, depending on the criteria used, the quality value/confidence value may be set to zero if the failure in liquid handling at the corresponding liquid detection segment is considered serious.

If some of the pixel positions in the indicator matrix contain a binary “1” and others a binary “0” this is indicative of the presence of both a liquid phase and a gas phase in the liquid detection segment. In this case the distribution of the different values in the liquid detection segment may be taken as an indication of abnormality and a low quality of the performance of the experiment or used for determining the confidence of the result obtained for the experiment. Such varied binaries in indicator segments may be indicative of an abnormality in the corresponding liquid detector segment, such as overflow microconduits and volume-metering microcavities. On the other hand if such varied binaries are present in the part of an indicator matrix corresponding to the space above the reaction microcavities/porous beds (104a-h) and are selectively distributed with binary 1 (presence of liquid) to the lower part and binary 0 (presence of gas) to the upper part, this will represent a liquid meniscus moving downwards through the porous bed according to the flow rate actually taking place through the bed. One can envisage that by repeatedly talking and processing images according to steps (C) to (F) during this kind of liquid transport it will be possible for the system with the proper software to determine the confidence of the liquid transport through the porous bed of each of the microchannel structures (101a-h). In this latter variant the lap counter is likely to be particularly valuable for image recording. However, the controller (e.g. 110 in FIG. 1) is capable of controlling all steps of an experiment run, with or without a lap counter.

The above mentioned confidence value/level may be defined as a liquid detection confidence value/level, which will be combined with other confidence values of the same experiment for determining a final experiment confidence value/level. The confidence determination means, performing the grading of the confidence value, is preferably implemented as a computer program software, which is capable of handling matrix algorithms and matrix processing, when inserted in a data processing means (computer and similar), such as the controller (110).

An alternative adjusted method may be used if one of the indicator segments is the inlet port. The microfluidic device is stopped in its home position. A digital image comprising all microchannel structures are registered by the image detector unit, i.e. the camera, and processed to background image. After the loading of the microchannel structures, a new image is recorded in step C, before the spinning of the disc starts (step B). The new image is processed with the mask filter generating a start matrix. The start matrix is processed with the background matrix for excluding the all microchannel structures that is not used in the experiment run. This will reduce the size of the different matrixes that is used in the method and the speed of the image processing will increase.

The above described method and principle is possible to combine with and use in other detection applications than an image detector. Hereafter, a modification of the above described method adapted for other detection arrangements will be explained.

In WO 03/102559-A1, a detector arrangement based on Surface Plasmon Resonance (SPR) is described. The detector arrangement comprises a rotatable microfluidic disc and a spectrophotometric detector unit. The microfluidic disc is adapted for driving liquid transport within the microchannel by centrifugal force (spinning). Therefore the disc has an axis of symmetry that coincides with a spin axis and microchannel structures, each of which has an upstream functional part that is at a shorter radial position than a downstream functional part. The disc is characterized in that there are detection microcavities (DMCs) in at least a part of said microchannel structures, and that each of said DMCs has an SPR surface on an inner wall and a detection window extending from the SPR surface to the surface of the disc. The detector arrangement and microfluidic disc described above is used for determining: a) the presence or absence of a liquid phase and/or a gas phase in one or more of the DMCs, and/or b) a feature of an analyte that is present in a liquid which is present in one or more of the DMCs. The detection microcavities used for detecting presence or absence of a liquid phase and/or a gas phase are comparable to the liquid detection segments of the microchannels discussed in the present invention.

A system for detecting fluids in a microfluidic component is described in US 2002/0145121 A1 by Huhn et al. The component has at least one microchannel including a limitation wall which has two surfaces which, facing the microchannel in a transparent area, are inclined towards each other at an acute angle, with the system further including a photo transmitter and a photo receiver which are disposed outside the component and are inclined surfaces in the transparent area of the limitation wall in such a way that if a gas is waiting in the microchannel on the two surfaces, a light ray emitted by the photo transmitter impinges on the photo receiver following a total reflection on the two surfaces and, if a liquid is waiting in the microchannel, the light ray enters the microchannel on at least one of the two surfaces and, as a result, the incidence of light into the photo receiver is reduced or prohibited.

In the above described known systems (WO 03/102559-A1; US 2002/0145121 A1), a detector unit is used for detecting, registering and recording a signal from one or more liquid detection segments of a microchannel structure. During rotation of the microfluidic disc/component, the illumination or irradiation system scans the microchannel structures or one or more of the liquid detection segments of one or more of the microchannel structures, and the detector unit registers the measured signal representing a physical parameter value/level for each structure. Therefore, the above-described method according to the invention for automatically determining a liquid detection confidence value is applicable to said liquid detection methods. Such an application will now be described roughly with reference to the embodiment described above for more details.

The first step, step A, is to collect, acquire, information from the unloaded microchannel structures (in which liquid detection is to take place) by means of the detector unit and the illumination/irradiation unit, i.e. in this case detect and record a background matrix, which corresponds to the transformed background image in the method described above, of the unloaded microfluidic device. The masking filter function described above is also used in the present embodiment. The background matrix is stored in an image-matrix memory, corresponding to the above described image-matrix memory.

Introduction of liquid and filling up the microchannel structures to the first valve position, step B, is performed in the same manner as described above for the inventive method. The next step, step C, is logically to collect, acquire, information from the loaded (with liquid aliquot of reagent or wash solution) microfluidic component by means of the detector unit and the eventual illumination/irradiation unit, i.e. in this case scan and record a signal representing the physical parameter matrix comprising the detected intensities of the scanned segments of the loaded microfluidic device.

A lap counter will record each pulse from the home mark detector when the home position mark passes. The lap counter and the controller of the system is used in essentially the same manner as already described.

Each Physical parameter will be processed and stored on a predetermined address, corresponding to the segment of the latest scanned microchannel structure, in an physical parameter matrix, which is similar to the above described image matrix. The masking filter will managing each unique address, or position, of the physical parameter matrix and the following mentioned matrixes relates to a specific, predetermined liquid detection segment of a microchannel structure on a disc.

In step D, the latest detected and stored segment physical parameter value in the Physical parameter matrix will be processed with the corresponding physical parameter value in the background matrix for generating a difference value which is stored in a corresponding address, or position, in the updating matrix, as above. Each physical parameter value that has been changed and differs from the corresponding physical parameter value in the background matrix more than a predefined threshold physical parameter value will result in an absolute physical parameter value (always positive) that differs from zero in the updating matrix.

In step E, a binary updating matrix is generated by processing the physical parameter value in the updating matrix by means of a binary filter transforming the absolute non-zero physical parameter segment values to a binary “1” if the physical parameter value exceeds a predetermined physical parameter value, i.e. more than the threshold physical parameter. This transform operation will ignore all physical parameter variations less than the threshold value. Such variation is always present and depends on other reasons than a detected liquid aliquot passing the segment and causing an physical parameter change in at least one microchannel segment.

In the next step, step F, the binary values of the binary updating matrix is combined with binary values in the indicator matrix from the previous itp/lap by a modulo-2-addition operation which generates a new indicator matrix. In the first lap, all pixel values is preset to binary “0”. Each one of the values of the binary updating matrix is combined with the corresponding value of the indicator matrix through a modulo-2 addition leaving the binary “1” of the indicator matrix unchanged and changing a binary “0” to “1” if the updating matrix have a “1” in the corresponding pixel position. This is necessary, as the liquid aliquot may only pass the segment and the physical parameter value of the pixels in the segment will return to the physical parameter value of the background matrix is very close to said physical parameter value. As the binary “1” remains in the indicator matrix, said binary “1” in the pixels positions of a segment will indicate that the liquid aliquot at least passed the segment.

For each new lap, a new scanning of each segment is recorded, step C, a new updating matrix is generated, step D, a binary updating matrix is generated from the updating matrix, step E, and the new updating matrix is combined, in step F, with the indicator matrix from the previous (latest) lap through a modulo-2 addition leaving the binary “1” unchanged and changing a binary “0” to “1” if the updating matrix has a “1” in the corresponding pixel position. This is necessary, as the liquid aliquot may only pass the segment without staying in the segment and the physical parameter value of the pixels in the segment therefore will return to the physical parameter value of the background image or very close to said physical parameter value. As the binary “1” remains in the indicator matrix, said binary “1” in the pixels positions of a segment will indicate that the liquid aliquot at least passed the segment.

When a sub-run of the experiment is finished, the final Indicator matrix of the sub-run is stored by the controller, step G. When the run, or experiment, is stopped by the controller, the stored indicator matrixes from the sub-runs are analyzed by a confidence determination means in the confidence determination step, step H, as already have been described in the embodiment of the invented method using images.

The above mentioned confidence value/level may be defined as a liquid detection confidence value/level, which will be combined with other confidence values of the same experiment for determining a final experiment confidence value/level.

A preferred embodiment of the invention will now be described.

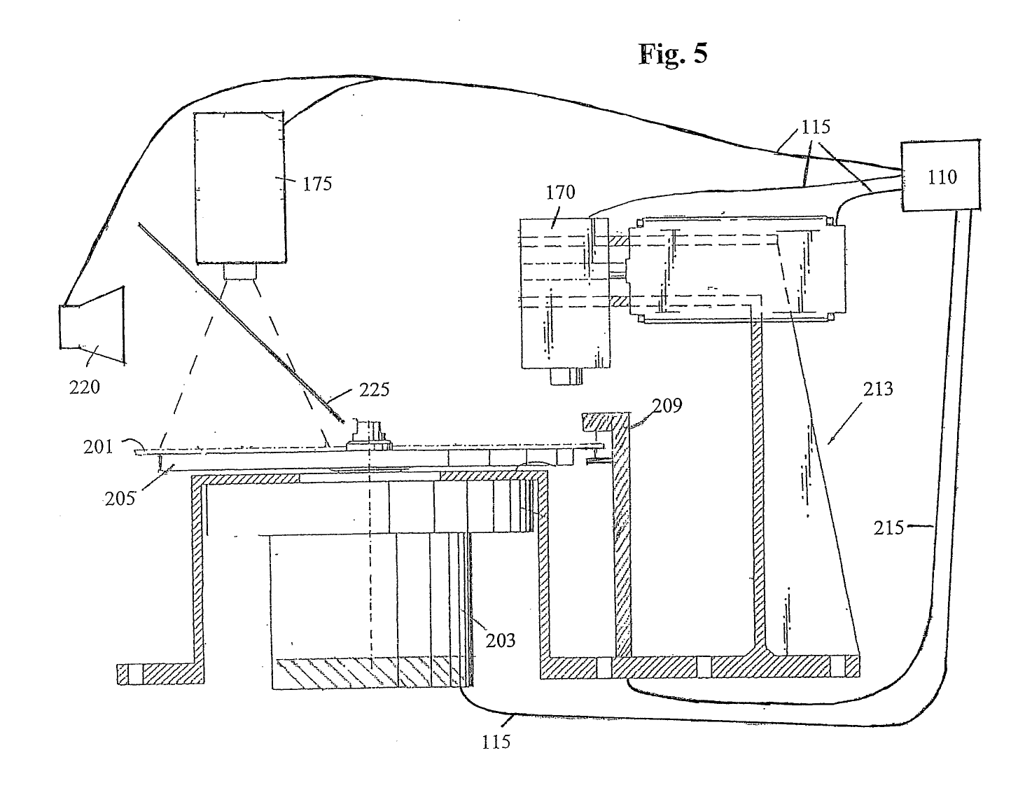

In FIG. 5 is illustrated a preferred embodiment of the arrangement in a microfluidic system according to the invention. Most parts of the invented microfluidic system and arrangement according to FIG. 5 are already described in this specification text concerning FIGS. 1, 2 and 3, and the description of these common parts will therefore not be repeated.

The arrangement according to FIG. 5 shows besides the already described parts an illuminating unit 220. Such an illuminating unit has been mentioned in the specification above to be a part of the invented system and arrangement but has not been illustrated in the previous figures. The illuminating unit is able to generate flashes or continues light of controlled intensity and colour (or electromagnetic frequency interval) giving the best conditions for the used liquid detector station 175 to distinguish device substrate, microfluidic channel structure, gas and liquids within the microfluidic channel structure. Any light source may be chosen as illuminating unit 220, but a flash generating device, e.g. strobe lamp, flashgun, re-loadable photoflashes etc., is preferably used.

The illuminating unit 220 may be arranged in many different ways in relation to the microfluidic device. In FIG. 5, the illuminating unit is positioned to send the flashes parallel to the plane of the microfluidic device towards a semi-permeable mirror that is arranged between the detector device 175 and the microfluidic device 201.

The semi-permeable mirror 225 may be arranged in many different ways in relation to the microfluidic device. In this embodiment, the mirror is arranged to illuminate a part of the microfluidic device, but is also possible to arrange said mirror in a way that the whole area of the microfluidic is illuminated. It is desirable that the whole area to be detected and/or reproduced as an image by the detector device is illuminated with a flash intensity that is distributed equally (i.e. the same intensity) throughout the whole area. Some of the flash (intensity) will be passing through the mirror 225 and the rest will be directed by the mirror towards the microfluidic device area to be detected.

Some of the flash intensity that hits the microfluidic device area will be lost due to the fact that it will be able to pass through the microfluidic disc or due to scattering. However, enough intensity will be reflected back to the mirror. When the light passes from one material to another, the reflected and transmitted intensities will depend on the difference in refraction indexes of the reflecting substances and materials, e.g. device substrate (plastic), gas or liquid. Regarding gas or liquids, the reflected intensity will differ due to that light refracts at the inner walls of the microfluidic channels. The difference of the reflected intensity will therefore be characteristic and usable when interpreting the image whether an area contains gas or liquid or is the substrate of microfluidic device. Some of the reflected intensities from different areas will pass through the semi-permeable mirror and will hit the detector transducer elements. In this embodiment, a digital camera is used which transducer elements are picture transistor elements, so called pixels, each element being able to transform incoming intensity to an electric signal/pulse which amplitude/height/length is proportional to the electromagnetic intensity. The resolution of the image depends of the amount of pixels.

Said flash unit 220, semi-permeable mirror 225 and camera 175 is well-known and a number of different semi-permeable mirrors and cameras are available on the trade market. It is not regarded as a problem to a skilled person to test and select the appropriate flash unit, semi-permeable mirror and camera giving the best result, i.e. the best image.

A preferred embodiment of the invented method will now be described in more detail. This method will also make use of the masking filter and the fact that each segment area of an image represents a known volume of a corresponding microfluidic structure on the disc.

The following description will treat an embodiment of the method wherein a number of sector images are required for covering the whole area of the microfluidic device, which in this case is a disc 201 that is spun during the experiment run. Each image contains only a sector part of the disc or the whole disc. If five images are registered during a lap, said five sector images will cover the whole area of interest of the disc. A lap is therefore divided by using an appropriate integer dividing a spinning lap into sectors resulting in sectors that are identical regarding the number of microfluidic channel structures and their positions in the sector. This measure will result in identical sector images. By adjusting the masking filter to one of the sector images, the same masking filter will be possible to use for all the other sector images. In other case, a masking filter has to prepared for each one of the sectors. Using identical sectors will therefore save a lot of time and computer processing.

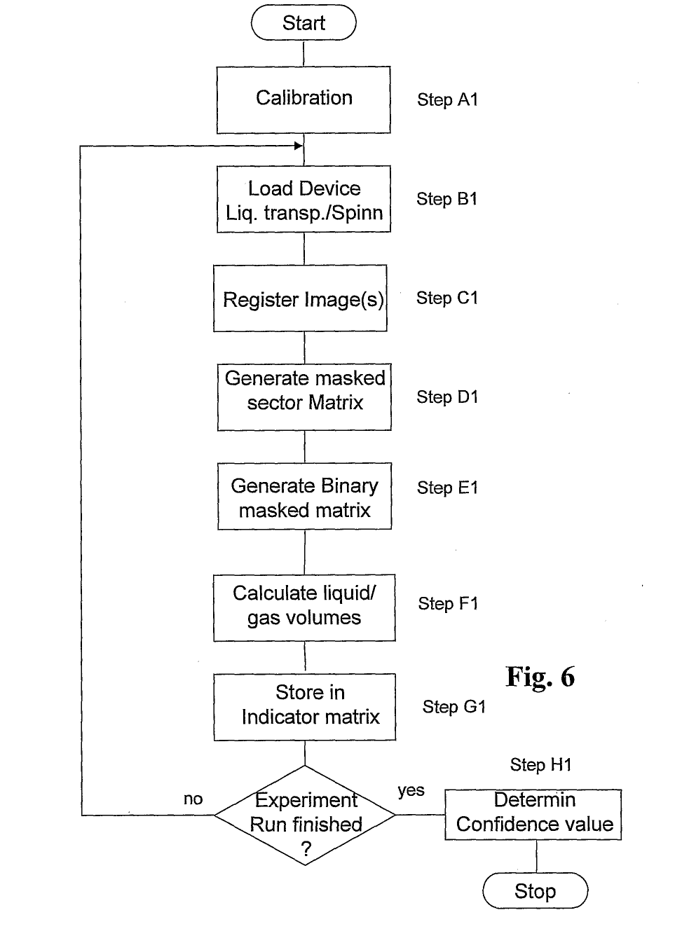

With reference to FIG. 6, steps involved in a preferred embodiment of the invented method will be described hereafter. The sector images and the masking filter has also to be correctly positioned so the segments of the masking filter and in the sector images will be identically positioned over their corresponding volumes of the sector area of a disc. Step A1 is a calibration step in which the illumination unit, camera, the controller and the masking filter is synchronised and calibrated to be able to map the defined segments exactly on their corresponding liquid detection segment areas of the disc, i.e. the areas containing the volumes of interest in each microfluidic channel structure. The positioning is easily defined by using the local coordinate system defined by the home mark and centre axis of the disc. Position coordinates on the disc are defined by the radius from said centre and the angle from the line defined between the centre and the home mark.

By measuring known coordinates within a sector on the disc and comparing to corresponding coordinates within a sector image, it is possible to calculate an offset, an angle and a scale factor which differ the coordinate system of the image from the coordinate system of the disc. Said offset, angle and scale factor will be used for transforming position coordinates on the disc to pixel coordinates in the image. Said transformation will be used for setting up the masking filters of the segments.

After having performed the calibration step, the microfluidic system is prepared for experiment running. The preferred embodiment excludes the running of the earlier described step A, i.e. the detection and recording of a background matrix.

Loading step B1, the loading of liquid in the microfluidic channels on the microfluidic disc, is similar to step B, which has been described above.

In step C1, after the loading of all microfluidic channel structures to be used for the experiment, the disc is rotated very slowly and an image is registered by the camera for each one of the sectors as one by one of the sectors passes the camera slowly when each of the sectors is in the correct position for generating an itp and registering a sector image, i.e. an image of each sector.

In step D1, each registered sector image is processed with the masking filter resulting in a masked sector (indicator) matrix for each sector (A masked sector matrix may be denoted as masked sector indicator matrix). The controller software will store on an appropriate data storage medium in each of one or more segment indicators, corresponding to the liquid segment detectors, physical parameter values representing presence and/or absence of liquid and/or gas detected in step C1, wherein each segment indicator relates to a specific liquid detector segment.

In step E1, the masked sector (indicator) matrix is processed with a binary function as described in step E above. The result is a binary masked sector matrix containing the segment indicators in the sector.

A threshold function will be used in step E1. Pixels having lower intensities than the threshold intensity value will receive the pixel intensity “0” and pixels having higher intensities will receive the pixel intensity “1”. The binary value “0” will therefore indicate liquid and the binary value “1” will indicate gas (or empty space). However, it is possible to define the binary value “0” as gas and the binary value “1” as liquid. Note, that the pixel intensities may be encoded to other binary values than “0” and “1”, e.g. “01” or “10” or even more bits.

In step F1, the segment indicators of the masked sector indicator matrixes belonging to a microfluidic channel structure will be used for determining the volume of liquid and gas in each segment indicator. Step F1 is repeated for each used channel in the experiment. Step F1 will be now be described in more detail.

It is assumed that the structure depth dₛ of each segment of the structure is known. Each pixel corresponds to a fraction area ΔA of the total segment area of a certain segment and said fraction area corresponds to a fraction volume dₛ·ΔA of the total fraction volume of said certain liquid detection segment in the channel. The fraction volume dₛ·ΔA is hereafter denoted as denoted the segment pixel volume coefficient cᵥ.

cᵥ=dₛ·ΔA

By counting the number n of pixels having a certain pixel value and multiply said number of pixels n with the coefficient cᵥ=dₛ·ΔA, the corresponding volume V is obtained.

V=n·cᵥ=n·dₛ·ΔA

The first segment of a microfluidic channel corresponds to the first volume of said microfluidic channel, and so on. A second segment of a microfluidic channel corresponds to a second volume of said microfluidic channel. The total depth dₛ₁ of the first volume of the first volume may differ from the total depth dₛ₂ of a second volume. of the last volume. Therefore, the first segment pixel volume coefficient cᵥ₁ will differ from the second segment pixel volume coefficient cᵥ₂.

In each segment, the number of pixels n_{liquid} having pixel intensity “0” (or “1”) will therefore correspond to a volume of liquid and the number of pixels n_{gas} having pixel intensity “1” (or “0”) will correspond to a volume of gas (or liquid).

V_{liquid1}=n_{liquid}·cᵥ₁=n_{liquid}·dₛ₁·ΔA; and

V_{gas1}=n_{gas}·cᵥ₁=n_{gas}·dₛ₁·ΔA

Hence, by multiplying the correct segment pixel volume coefficient with the number of pixels having pixel intensity value “0” and the number of pixels having pixel intensity value “1” respectively, it is possible to calculate the volume of liquid and volume of gas within each segment/volume.

In step G1, the result of the calculation of the volume of liquid and volume of gas within each segment/volume will be stored in a sector indicator matrix.

When all sectors are imaged during the first lap, the spinning treatment of the disc can start and the disc will be spun according the pre-programmed procedure in the controller. During this pre-programmed procedure, it is possible to repeat steps C1 to G1 as many times it is wished resulting in new sector indicator matrixes. It is possible to register new sector images in full speed without slowing the disc down as described in step C1.

When the spinning treatment is finished, steps C1 to G1 is repeated.

During the spinning treatment, the liquid in the first volume corresponding to the first segment of the microfluidic channel structure is transported to the last volume corresponding to the last segment and the last volume has been filled by the liquid from the first volume.

The sector indicator matrixes belonging to the first lap and last spinning lap are therefore of special interest. In step H1, the indicator matrixes belonging to a microfluidic channel structure will be used for determining the confidence value of the experiment of said microfluidic channel structure. Step H1 will be now be described in more detail.

By analysing the stored calculated volumes of each microfluidic channel one by one in the sector indicator matrixes, it is possible to determine how much the expected volumes of liquid V_{liquid} and gas V_{gas} respectively within the first and last segment indicators are deviating from expected preset volume values. The more the calculated volumes of gas and liquid in the segments for a microfluidic channel are deviating from said expected values, the lower confidence value is set for that microfluidic channel.

In another embodiment of the invented method, steps F1 and step G1 may be included as sub-steps in step H1.

The present invention may be implemented as a computer program product comprising a computer usable medium and a software code means loadable into an internal memory storage of a data processing unit within a controller in a microfluidic system, which will be capable of performing the steps of any claims 1-21 when the software code means is executed by the data processing unit within the controller in microfluidic system.

Further, the present invention relates to a computer program comprising software code means stored on a computer usable medium, from which the software code means is readable by the computer means, the software code means is capable of causing a data processing unit in a computer means of a microfluidic system to control and perform an execution of the steps of any of the claims 1-21.

The computer usable medium may be any of following storage or carrier devices: record medium, a hard disk, floppy disk, floppy disk drive, optical disk drive, a computer memory, a Read-Only Memory, magnetic cassettes, flash memory cards, digital video disks, random access memories or an electrical carrier signal.

The present invention is not limited to the above-described preferred embodiments. Various alternatives, modifications and equivalents may be used. Therefore, the above embodiments should not be taken as limiting the scope of the invention, which is defined by the appended claims.

1. A method for grading the confidence of a result of an experiment that comprises one or more biological and/or chemical reactions and is carried out in a microchannel structure a microfluidic device, which is adapted to permit liquid transport caused by spinning,
said experiment comprises the liquid processing steps of:
a) introducing one or more liquid aliquots into an inlet function of said microchannel structure
b) transporting and processing these aliquots and/or one or more aliquots derived therefrom during the processing (=derived aliquots) within said microchannel structure, and
c) determining the result of the experiment in said detection zone of said microchannel structure,
wherein said confidence determination comprises the steps of:
i) detecting within each of at least one liquid detector segment of said microchannel structure the presence or absence of liquid and/or gas during a period of time for which it is known if liquid and/or gas shall be present and/or absent in the segment, and
ii) assigning by computer means a lowered confidence to said result if the presence and/or absence of liquid and/or gas found in step (i) is deviating from what it shall be.

2. The method according to claim 1, wherein step (ii) comprises the steps of:
storing in each of one or more segment indicators of an appropriate data storage medium physical parameter values representing presence and/or absence of liquid and/or gas detected in step (i), wherein each segment indicator relates to a specific liquid detector segment, and
determining confidence from one or more of said segment indicator(s).

3. The method according to claim 2, wherein step (ii) comprises that said confidence determination comprises that at least one of the segment indicators comprise one or more physical parameter values that indicate presence of liquid and/or gas, and/or one or more physical parameter values that indicate absence of liquid and/or gas.

4. The method according to claim 2, wherein said confidence determination comprises the step of:
determining confidence from one or more of the segment indicator(s) comprising one or more parameter values wherein the segment indicator indicates presence of a liquid-gas interface (meniscus).

5. The method according to claim 2, wherein said confidence determination comprises the step of:
determining confidence from one or more of the segment indicator(s) comprising one or more volume values, V_{liquid} and/or V_{gas}, that indicate presence of liquid and/or gas, and/or one or more physical parameter values that indicate absence of liquid and/or gas.

6. The method according to claim 1, wherein said confidence determination comprises the step of:
determining a final experiment confidence by use of one or more confidences, wherein at least the confidence determined according to the steps in claim 1 is one of the confidences used.

7. The method according to claim 2, wherein said physical parameter value is an intensity value/level.

8. The method according to claim 2, wherein said confidence determination comprises the step of:
using a masking filter function for determining size, position and resolution of each segment indicator.

9. The method according to claim 1, wherein said microchannel structure comprises in the downstream direction
a) the inlet function,
b) a zone for carrying out reactions that are biological and/or chemical (reaction zone),
c) a zone in which results of the reactions/experiments are detected (detection zone), and
d) an outlet function, the detection zone and the reaction zone possibly fully or partly coinciding.

10. The method according to claim 9, wherein at least one of said each segment is part of the inlet function.

11. The method according to claim 9, wherein
a) said inlet function comprises an inlet arrangement (IA), and
b) at least one of said each segment is present in said IA.

12. The method according to claim 9, wherein at least one of said each segment is located
a) between said inlet function and the reaction zone,
b) within the reaction zone,
c) between said reaction zone and said detection zone,
d) within said detection zone,
e) between said detection zone and said outlet function or
f) within said outlet function.

13. The method according to claim 9, wherein
a) said microfluidic device comprises a plurality of said microchannel structure which plurality typically is divided into subsets of microchannel structures with the microchannel structures within a subset being linked together by a common part of said inlet function and/or of said outlet function, and
b) at least one of said experiment and steps (i) and (ii) is carried out in parallel for two or more of said microchannel structures.

14. The method according to claim 1, wherein the liquid which absence and/or presence is detected in step (ii) is selected from
a) wash liquids,
b) conditioning liquids, and
c) liquids containing one or more reactants that are reacted in the reaction zone.

15. The method according to claim 1, wherein
a) the liquid of step (ii) contains one or more reactants,
b) at least one of said segments is part of said inlet function, and
c) optionally at least one of said reactants being required in the experiment with an accuracy with an inter-experiment variation of ±30%.

16. The method according to claim 14, wherein at least one of said reactants is a reagent.

17. The method according to claim 14, wherein
(a) at least one of said reactants is an entity to be characterized, and
(b) the experiment is an assay for characterizing said analyte.

18. The method according to claim 1, wherein the method is carried out in a system comprising
a) the microfluidic device, and apparatus for processing the microfluidic device,
b) a detector unit for detecting said result in the detection zone,
c) a sensor unit for carrying out step (i), and
d) software and computer for carrying out step (ii).

19. The method according to claim 18, wherein the sensor unit is based on detecting the interface between liquid and gas or the presence and/or absence of gas and/or liquid, for instance by image analysis.

20. The method according to claim 18, wherein the sensor unit is based on the difference in refractive index for gas and liquid.

21. The method according to claim 18, wherein the sensor unit is an image detecting unit, capable of generating a video signal, television signal or digital image signal.

22. A system for grading the confidence of a result of an experiment according to the method of claim 1 that comprises one or more biological and/or chemical reactions and is carried out in a microchannel structure of a microfluidic device, wherein said system for confidence determination comprises:
i) means for detecting within each of said segments the presence and/or absence of liquid and/or gas during a period of time for which it is known if liquid and/or gas shall be present or absent in the segment, and
ii) means for assigning a lowered confidence to said result if the presence and/or absence of liquid and/or gas found in step (i) is deviating from what it shall be.

23. The system according to claim 22, wherein the system comprises means for determining confidence from one or more segment indicators comprising one or more physical parameter values

24. The system according to claim 23, wherein the system comprises means for determining confidence from one or more segment indicators which each comprises one or more possible parameter values that indicate presence of liquid and/or gas during a period of time for which it is expected that liquid and/or gas shall be present in the segment, and/or one or more physical parameter value that indicate absence of liquid and/or gas during a period of time for which it is expected that liquid and/or gas shall be present in the segment.

25. The system according to claim 23, wherein the system comprises means for determining confidence from one or more segment indicators comprising one or more parameter values which indicates presence of a liquid-gas interface (meniscus).

26. The system according to claim 23, wherein the system comprises means for determining confidence from one or more segment indicators comprising one or more volume values, V_{liquid} and/or V_{gas}, that indicate presence of liquid and/or gas, and/or one or more physical parameter values that indicate absence of liquid and/or gas.

27. The system according to claim 22, wherein the system comprises means for determining a final experiment confidence by use of one or more confidences, wherein at least the confidence determined according to the steps in claim 1 is one of the confidences used.

28. The system according to claim 23, wherein said physical parameter value is an intensity value/level.

29. The system according to claim 23, wherein the system comprises a masking filter function for determining size, position and resolution of each segment indicator.

30. The system according to claim 22, wherein said microchannel structure comprises in the downstream direction
a. an inlet function,
b. a zone for carrying out reactions that are biological and/or chemical (reaction zone),
c. a zone in which results of the reactions/experiments are detected (detection zone), and
d. an outlet function, the detection zone and the reaction zone possibly fully or partly coinciding.

31. The system according to claim 30, wherein at least one of said segment is part of the inlet function.

32. The system according to claim 30, wherein
a) said inlet function comprises an inlet arrangement (IA), and
b) at least one of said segments is present in said IA.

33. The system according to claim 30, wherein at least one of said segments is located
a) between said inlet function and the reaction zone,
b) within the reaction zone,
c) between said reaction zone and said detection zone,
d) within said detection zone,
e) between said detection zone and said outlet function or
f) within said outlet function.

34. The system according to claim 29, wherein
a) said microfluidic device comprises a plurality of said microchannel structure which plurality typically is divided into subsets of microchannel structures with the microchannel structures within a subset being linked together by a common part of said inlet function and/or of said outlet function, and
b) at least one of said experiment and steps (i) and (ii) are carried out in parallel in two or more of said microchannel structures.

35. The system according to claim 28, wherein the system comprises
a) the microfluidic device, and apparatus for processing the microfluidic device,
b) a detector unit for detecting said result in the detection zone,
c) means for detecting within a segment of said microchannel structure the presence or absence of liquid and/or gas is a sensor unit for carrying out step (i), and
d) means for assigning a confidence to said result if the presence and/or absence of liquid and/or gas found is implemented as software code means stored in computer means for carrying out step (ii) of claim 1.

36. The system according to claim 35, wherein the sensor unit is based on detecting the interface between liquid and gas, for instance by image analysis.

37. The system according to claim 35, wherein the sensor unit is an image detecting device that is capable of generating said physical parameter values to be stored in said segment indicators in an image storage/memory for further processing by said computer means and software code means.

38. The system according to claim 35, wherein the detector unit is based on the difference in refractive index for gas and liquid.

39. The system according to claim 35, wherein the detector unit is a spectrophotometric (SPR) detector.

40. The system according to claim 35, wherein the sensor unit and/or the detector unit is an image detecting unit, capable of generating a video signal, television signal or digital image signal.

41. A computer program product comprising a computer usable medium and a software code means loadable into an internal memory storage of a data processing unit within a controller in a microfluidic system, which will be capable of performing the steps of claim 1 when the software code means is executed by the data processing unit within the controller in microfluidic system.

42. A computer program comprising software code means stored on a computer usable medium, from which the software code means is readable by the computer means, the software code means is capable of causing a data processing unit in a computer means of a microfluidic system to control and perform an execution of the steps of claim 1.

43. The computer program according to claim 42, wherein the computer usable medium is any of a record medium, a hard disk, floppy disk, floppy disk drive, optical disk drive, a computer memory, a Read-Only Memory, magnetic cassettes, flash memory cards, digital video disks, random access memories or an electrical carrier signal.
